(19) United States
(12) Patent Application Publication
(10) Pub. No.: US 2013/0173485 A1
(43) Pub. Date: Jul. 4, 2013

(54) COMPUTER-IMPLEMENTED METHOD TO CHARACTERISE SOCIAL INFLUENCE AND PREDICT BEHAVIOUR OF A USER

(71) Applicants: David Millan RUIZ, Madrid (ES); Miguel Angel Rodriguez CRESPO, Madrid (ES); Ruben Lara HERNÁNDEZ, Madrid (ES)

(72) Inventors: David Millan RUIZ, Madrid (ES); Miguel Angel Rodriguez CRESPO, Madrid (ES); Ruben Lara HERNÁNDEZ, Madrid (ES)

(73) Assignee: TELEFONICA, S.A., Madrid (ES)

(21) Appl. No.: 13/340,102

(22) Filed: Dec. 29, 2011

(51) Int. Cl. G06G 7/48; G06Q 99/00

(52) U.S. Cl. 705/319

(57) ABSTRACT

It is characterised in that it comprises creating with computing means a multidimensional profile of a user including at least a prediction of behaviour of said user and a characterisation of social influence of said user, said prediction of behaviour comprising:
a) applying predictive models to individual factors;
b) calculating influence received by said user from a social circle, said calculation based at least on previous events and Social Network Analysis Information, said previous events referred to behaviour or behaviours previously adopted by members of said social circle;
and said characterisation of social influence comprising simulating a determined behaviour in said user and estimating the effect caused over at least part of said members of said social circle.

### FIELD OF THE ART

The present invention generally relates to a computer-implemented method to characterise social influence and to predict behaviour of a user, said user being part of a social network, and more particularly to a computer-implemented method that comprises creating a multidimensional view of a user by incorporating a prediction of future behaviour decomposed on prediction of future behaviour based on individual factors and on the influence received from his social circles, and a characterisation of user influence across a number of metrics such as number of direct contacts potentially influenced, social connectivity of these contacts or their economic value.

### PRIOR STATE OF THE ART

The characterisation of influence among users, despite of being a recent field of study, has a large number of related publications that study the social networks obtained from big amounts of data and the spread of influence within them. The process of extracting information from communication data and the interaction among clients is used to model the relations through nodes and links and estimate the graph that represents the social network and also the information and influence flows.

Proposals [1] and [6] analyse the graphs created from online social network users, like Flickr or MySpace and develop some tests about their structure, properties and evolution. Also, they suggest to split the global social network in small graphs or communities, created by users with a strengthen relation and who are influenced by individual and social issues, for instance the number of close people who already belong to that community.

Proposal [7] studies some structural parameters of the network, like the distribution of incoming/outgoing calls to obtain the topology of nodes and their links. This topology is usually heterogeneous. In telecommunications networks, the Pearson-correlation measure is used to create a campaign for spreading a new product through word of mouth. This kind of algorithms, also known as influence-spreading algorithms, start with the activation of some clients specially chosen to transmit part of their energy (information) to their neighbours and, after some iterations, ‘infect’ all the network. In a similar way, for web pages the PageRank value is also utilized to measure their social importance in the global World Wide Web.

Similarly, proposal [4] uses the specific value of links between nodes in the social graph to solve the churn problem. The article assumes that churners influence other customers to churn. The topology of the network is also studied as a relevant factor to explain the propensity of customers to churn. Thus, an experiment is created with some churners as seeds to spread the influence to finally measure (with a decision-tree model) the estimated value of influence received by every node, under the assumption that the global level of energy is kept constant over time.

Proposal [5] defines the process of finding the most influential nodes for creating a cascade effect, found to be an NP-complete problem, and suggests an algorithm based on centrality measures and distance to the central nodes. Consequently, it is assumed that the fewer paths between nodes, the bigger the probability of influence spreading is. Some other aspects are also found to be important e.g. the number of active neighbours or the number of previous attempts of activation.

Some algorithms and heuristics are also proposed in [3] to try to improve the spread of influence. These new considerations about the network dynamics achieve better results in comparison to just considering the structural properties, as done in previous studies.

Finally, in [2], a new algorithm for modelling word of mouth is proposed, taking into account the real interactions between users and their order in order to find the most influential nodes. It considers not only the static properties of the network but also the communication dynamics between nodes.

Existing solutions present one or more of the following problems and limitations:
Influence is not measured and characterised based on observable user behaviours e.g. purchase of a product or churning from a telco operator. Instead, some of the existing works in the area, for instance those relying on SIR models, assume that each communication will transmit information influencing a particular behaviour with some probability, irrespective of the particular behaviour that is being modelled and the content or nature of the communication. This makes them theoretical models not grounded on the observed user behaviour.
Partial view of the factors that affect customer behaviour: existing approaches model and estimate in different ways how influence will flow in a social network, but most of them do not incorporate individual factors. User behaviour is rooted on both individual (age, personality, past and current experiences, etc.) and social factors (information received from other members of the social group, behaviour of social contacts, etc.). A prediction of user behaviour that does not take into account both types of information is therefore based on a partial view of the user.
Incomplete characterisation of user influence: existing works trying to characterise the influence potential of a user are based on elements like the size of simulated propagation cascades based on the user communication. However, having a usable characterisation of influence requires incorporating elements like the number of other users that can be directly influenced by the behaviour of a given user, and the type of users affected (in terms of economic value, potential to further spread the behaviour, socio-demographics of these users, etc.).
Lack of a community view: most of the published works model the spread of information or influence through the social network, but do not take into account the community structure that appears on social networks. They therefore neglect the different degree of influence exerted by members of a community on other members of the same community, as compared to influence exerted outside the community.
Granularity of the characterisation of influence: Influence can be described at an individual level, i.e., what total influence a user exerts on his social group or receives from it, but also at a social relation level, i.e., what influence customer X exerts on or receives from customer Y. Most works are limited to the first, aggregated view, but both are relevant in practical applications.
Focus on predicting behaviour or characterising influence, but without an integrated and actionable multi-dimensional view: Existing works focus either on the prediction of future user behaviour based on the influence received from his social circle e.g. a customer probability to churn as a result of other customers churning in his social context, or on the characterisation of the influence of a user e.g. size of the information or behaviour propagation cascades generated by a user. However, none of the existing works define a multi-dimensional view that describes at the same time the individual propensity of a user to adopt a given behaviour (e.g. adoption of a product), the propensity based on the influence he receives from his social group, and the potential propagation effect this user can generate measured in different ways (number of users affected, characteristics of these users, etc.). Such a multi-dimensional view is necessary to take informed actions e.g. targeting a particular product to some users based on a) likelihood to adopt it based on his individual profile and on the positive influence other users in his social groups exert on him, and b) their potential to propagate the adoption to their social circles.
Operational considerations: Existing methods do not introduce operational considerations, such as the frequency of update necessary for the characterisation of user influence, based on the particular propagation speed of the event being studied, or the temporal gap between the detection of a user being negatively influenced and the ability of taking an action to stop that influence. These considerations are necessary for the effective usage of these methods.
Scalability: Current methods have not been applied to massive social networks involving millions of users, and scalability has not been proven for social networks spanning entire countries.

### DESCRIPTION OF THE INVENTION

It is necessary to offer an alternative to the state of the art which covers the gaps found therein, particularly related to the lack of proposals which really measure user influence based on observable user behaviours and characterise completely the influence that a user can exert over other users.

To that end, the present invention provides a computer-implemented method to characterise social influence and predict behaviour of a user, said user being part of a social network.

On contrary to the known proposals, the method of the invention, in a characteristic manner, comprises creating with computing means a multidimensional profile of a user including at least a prediction of behaviour of said user and a characterisation of social influence of said user, said prediction of behaviour comprising:

a) applying predictive models to individual factors, said individual factors being observable, declared or inferred characteristics of said user;

b) calculating influence received by said user from a social circle, said calculation based at least on previous events and Social Network Analysis Information, said previous events referred to behaviour or behaviours previously adopted by members of said social circle;

and said characterisation of social influence comprising simulating a determined behaviour in said user and estimating the effect caused over at least part of said members of said social circle.

Other embodiments of the method of the invention are described according to appended claims 2 to 11, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings which must be considered in an illustrative and non-limiting manner, in which:

FIG. 1 shows a scheme of the multi-dimensional view of a user which includes a prediction of the user behaviour and a characterisation of the user's influence over a social network, according to an embodiment of the present invention.

FIG. 2 shows the functional blocks of the computer-implemented method in order to obtain said multidimensional view of a user, according to an embodiment of the present invention.

FIG. 3 shows the training stage when performing the prediction of user behaviour based on the received influence from social circles, according to an embodiment of the present invention.

FIG. 4 shows the prediction stage when performing the prediction of user behaviour based on the received influence from social circles, according to an embodiment of the present invention.

FIG. 5 illustrates the process to obtain a prediction of future events based on the received influence, according to an embodiment of the present invention.

FIG. 6 show the steps of the algorithm to obtain the received influence scores, according to an embodiment of the present invention.

FIG. 7 illustrates graphically the algorithm to obtain the received influence scores, according to an embodiment of the present invention.

FIG. 8 illustrates that a given costumer can be influenced when simulating that any of his contacts is following a rumour or event.

FIG. 9 shows the steps of the algorithm to obtain the influence metrics, according to an embodiment of the present invention.

FIG. 10 illustrates graphically the algorithm to obtain the influence metrics, according to an embodiment of the present invention.

### DETAILED DESCRIPTION OF SEVERAL EMBODIMENTS

User behaviour is rooted in both individual and social factors. Individual factors are observable, declared or inferred characteristics of a particular user, and can include, for example, age, socioeconomic level or attitude towards technology. Social factors refer to the structure of his social relations e.g. size of his social circle or strength of each of his social relations, the social influence he receives from his social groups, and the social influence he exerts to them, possibly causing certain behaviour in them.

In order to predict the future behaviour of a user, none of these factors can be neglected. At the same time, characterising what influence a given user can exert on his environment is necessary in order to decide whether it is important to prevent or, on the contrary, motivate certain behaviour of a customer. An example of the former is preventing a customer from churning if he will cause many other users to also churn; an example of the latter is motivating him to use a service if he will spread the usage to his social circles. Finally, the characteristics of the users potentially influenced by an individual are also relevant for driving what actions must be taken e.g. economic value of these users, social connectivity (possible cascade effect), or socioeconomic level.

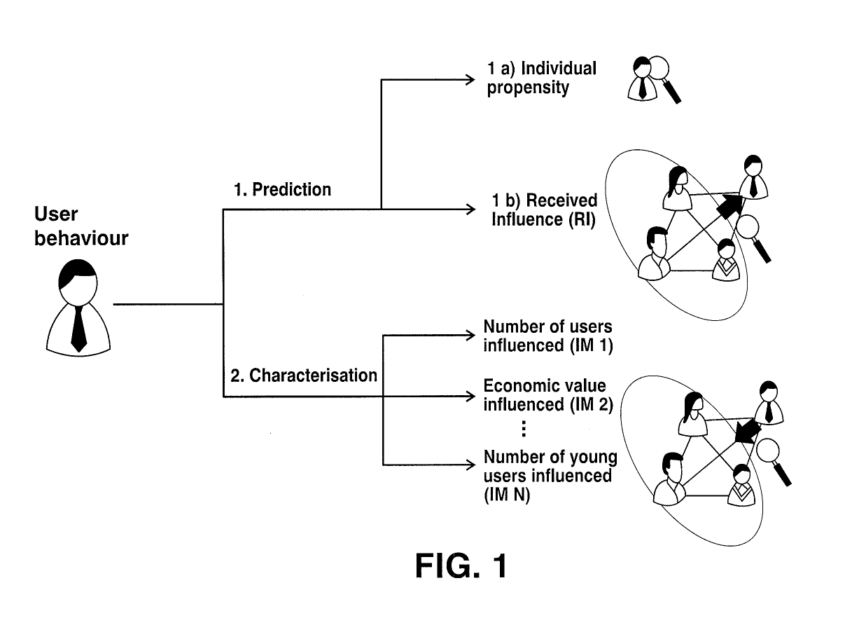

In this invention, a computer-implemented method that creates a multidimensional, actionable view of the user is proposed, incorporating the following components, as shown in FIG. 1:

1. Prediction of future user behaviour, decomposed in:

a) Prediction of future user behaviour based on individual factors.

b) Prediction of future user behaviour based on the influence received from his social circles.

2. Characterisation of user influence across a number of metrics: number of direct contacts potentially influenced, social connectivity of these contacts, their economic value, and their micro-segments (age, socioeconomic level, interests and preferences, usage of technology . . . ).

This view is created for every user for a particular event at study, and taking into account the temporal dimension and operational constraints: how fast a given behaviour propagates, or how fast the company can react to the behaviour prediction.

For the component 1.a), predictive models based on individual characteristics and the history of user behaviour are used to generate a propensity of the user to adopt a certain behaviour.

For the component 1.b), a measure called Received Influence (RI) is calculated. This measure denotes the influence a customer receives from his social environment, and it ranges from 0 (he does not receive any influence from their contacts) to 1 (highly influenced). As it will be later described, the calculation of this measure is based on the behaviour adopted by other members of the user's social circles, the relation of the user to these other users, and the general configuration of the user's social network. The RI is set to 0 for individuals who are not socially connected to anyone who has adopted the behaviour being studied.

For the component 2, a simulation is performed: one user adopts the behaviour being studied (e.g. following a rumour, purchasing a product, contracting a service, etc) and run the predictive model of component 1.b) to estimate the effect/influence he would cause on each of the members of his social circle, generating a number of Influence Measures (IMs). These IMs determine how influential a given customer is, when spreading any kind of information (e.g. a customer may be very influential for spreading news related to politics but not for those related to computing as he may not be an expert on this subject). This mechanism allows for measuring the potential influence a user can exert on each individual in his social groups, and therefore analysing this influence in different ways and across different dimensions: total number of users influenced, economic value of the users highly influenced, social connectivity of these users, and influence per micro-segment. Then, this detailed view can be aggregated along each dimension or group of dimensions. In this way, a granular and flexible view of influence can be provided for each individual in the social network.

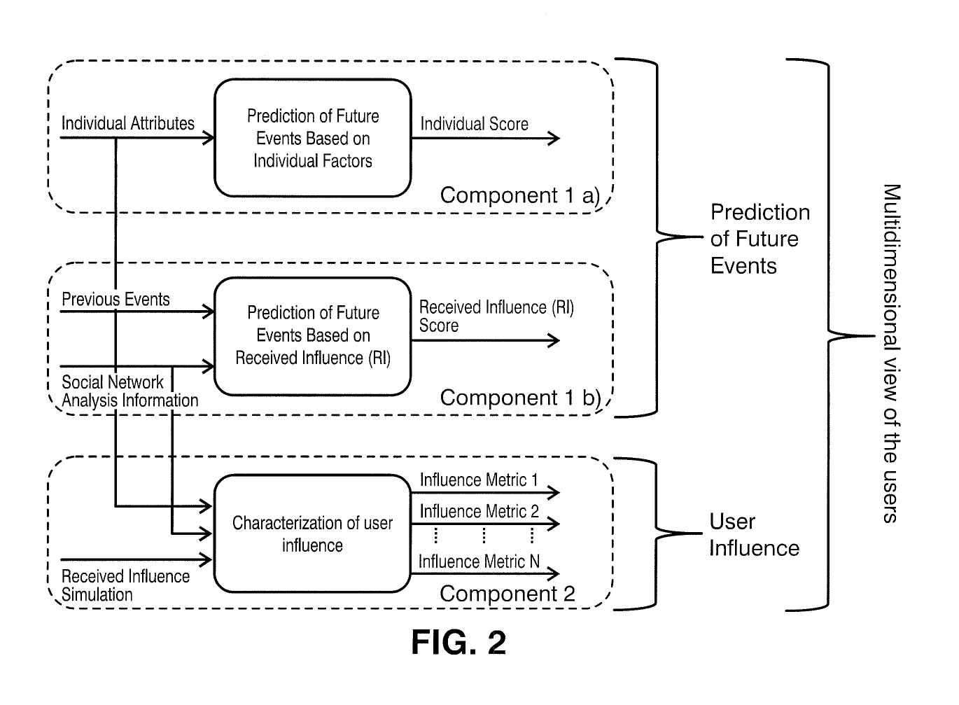

The functional blocks (components) defined and how they are combined were summarised in FIG. 2.

Prediction of Future User Behaviour Base on the Received Influence (RI) from his Social Circles

The goal of this component of the invention is to compute a pressure score (Received Influence, hereafter RI) for every user that is considered under influence from a previous event type (churn, acquisition of a new product or service, etc). This element is one of the main novelties of this invention.

Not all the users are considered under influence from previous events (or rumours) as they may not be related to people trying to influence them (maybe without realising). The first step of this component is to accomplish the task of identifying the users who may be under influence by analysing the relationship they hold with their contacts. The users considered non-influenced are assigned a pressure score equal to 0.

At the very beginning of this process, the information about previous events (influence seeds: people following a rumour/event) and current customers is updated, collected and prepared. The seeds are collected over a previous period of time that can be varied (for example, one week or one month).

Then, the influence area is defined as the set of users who are in the neighbourhood of at least one influence seed. This neighbourhood is defined based on the communities an influence seed belongs to, and on the links an influence seed has to other users. One user is considered under influence if he belongs at least to one community in which there is an influence seed and whether he has a direct link to an influence seed (direct communication between both users).

Once the set of users inside the influence area is defined, they are characterised using the information available from their communities and social network. This characterisation is made by calculating a set of variables (predictors) based on the neighbourhood of every user in the influence area. These variables are obtained from the number, link strength, and type of the users belonging to the neighbourhood of the user under influence. Regarding the type of the users in the neighbourhood, a very important one is which ones are seeds. Based on predictors as the number and link strength of seeds in the neighbourhood, it is useful to derive other predictors as the ratio of number of seeds to the total number of neighbours, or the ratio of the sum of the links weights to seeds to the sum of all the links in the neighbourhood.

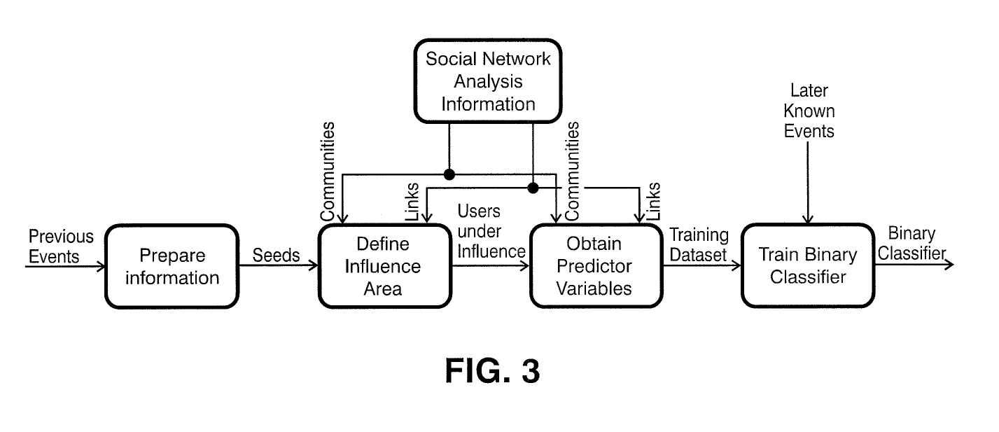

This way, a dataset is available in which every user in the influence area is assigned a set of variables (predictors). This dataset can be used to train a binary classifier (statistical model) using known events of historical data; that is, whether a particular user under influence adopted the same behaviour (produced the same event) as the influence seeds that influenced that user. This is the training stage of this component, as shown in FIG. 3.

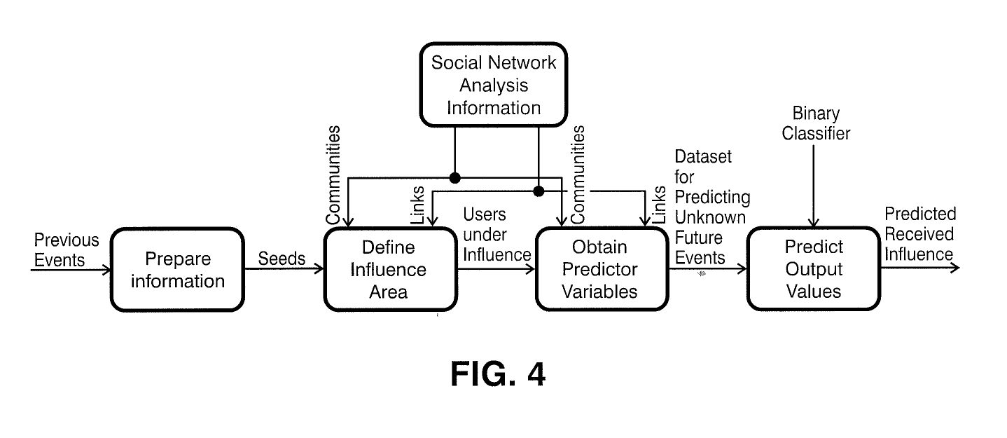

Once a binary classifier has been trained and is available, it can be applied to predict future events based on a dataset created from new seeds. The model assigns a prediction value to each user under influence (pressure score or received influence). This is the prediction stage of this component, as shown in FIG. 4.

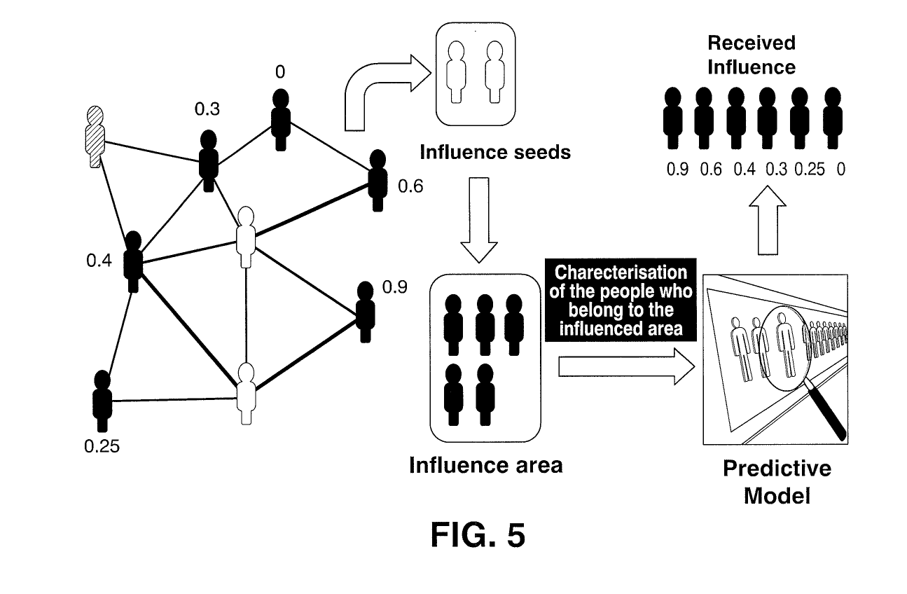

FIG. 5 reflected that any people following a “rumour” (called “influence seeds” as they are the origin/source of the influence) can also spread such information through the social network, reaching their contacts/friends from their social circles. As previously mentioned, the set of people being potentially influenced by the influence seeds is called “influence area”.

Then, the relationship between influence seeds and the influenced people from the influenced area is characterised, according to the social interactions they hold, the characteristics of the social network, the type of event or rumour being studied and of course the individual attributes of each user (e.g. age, genre, etc.).

Finally, a predictive model is applied to figure out what influenced people will follow the rumour of the influence seeds. The predictive model sets up a score to each influenced contact.

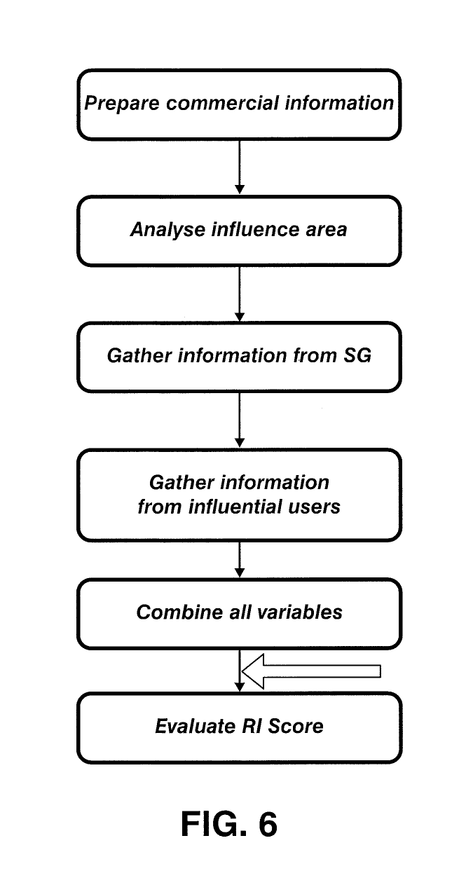

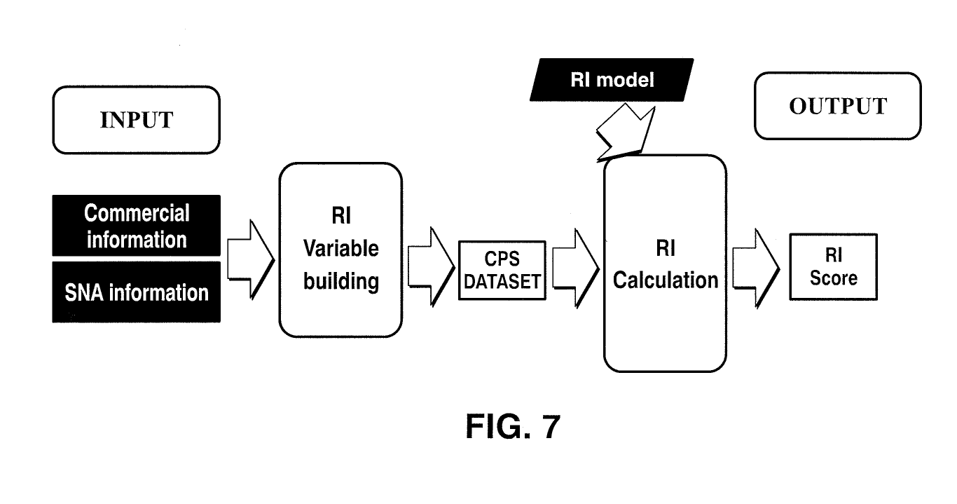

In order to wrap up the description of this component, it is provided the algorithm to implement the entire concept exposed along this section (FIG. 6 and FIG. 7 expressed graphically the inner of the algorithm textually described below).

Bear in mind that the following steps will be executed sequentially:

1. Prepare commercial information: Update information on new rumour adopters and subscribers.

2. Define influence area: It will be formed by the subscribers who are in the neighbourhood of the influence seeds (people who have followed a given rumour).

3. Gather information from Social Graph: For each user who is in influence area, get information about his contacts.

4. Gather information from influence: For each user who is in influence area, get information about his neighbourhood.

5. Combine information: Including information about the social graph, influencers, social network metrics and commercial information to create the RI dataset. This dataset will be used for training (when in training mode) and for scoring (when in execution mode).

6. Evaluate RI: Applying a previously generated statistical model (binary classifier) and generating a score for each user who is in influence area based on his variables.

Characterisation of User Influence to Determine the Influence Metrics (IM) of a Given User

The main aim of this component of the invention is to determine and measure how influential each user of the social network is, by analysing the impact he would cause on his community when following a certain rumour.

This module is supported by the previously described module as it is simulated what would happen if a given user adopts the behaviour/rumour being studied (e.g. following a rumour, purchasing a product, contracting a service, etc) by employing the module of received influence for each user of the social network.

The process has two main stages:

1. Simulation of RI: each user (one-by-one) follows the rumour being studied in order to evaluate his effect on his contacts. This simulation is made by running the predictive model of “Component 1 b)” to estimate the effect/influence each user would cause on each of the members of his social circle, generating a number of Influence Metrics (IMs). These IMs determine how influential a given customer is, when spreading any kind of information (e.g. a customer may be very influential for spreading news related to politics but not for those related to computing as he may not be an expert on this subject). This mechanism allows for measuring the potential influence a user can exert on each individual in his social groups, and therefore analysing this influence in different ways and across different dimensions: total number of users influenced, economic value of the users highly influenced, social connectivity of these users, and influence per micro-segment. Then, this detailed view can be aggregated along each dimension or group of dimensions.

2. Study of these variables—created from simulation—from the influential point of view, to accumulate the consequences it has over the influenced users. In this way, a granular and flexible view of influence can be provided for each individual in the social network.

While RI score ranges from 0 to 1, IM score may take values in the range [0,N].

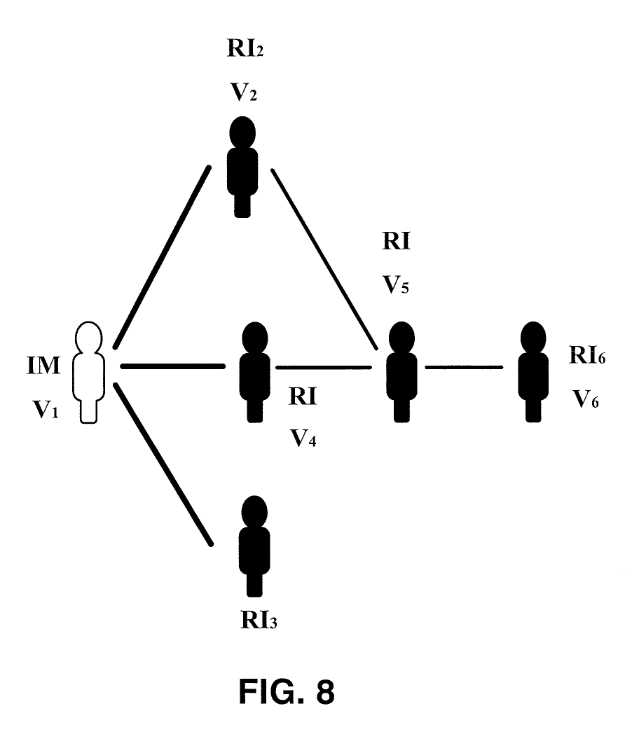

FIG. 8 showed how influential a given customer can be by simulating that any of his contacts can also follow the “rumour” (characterisation of influence).

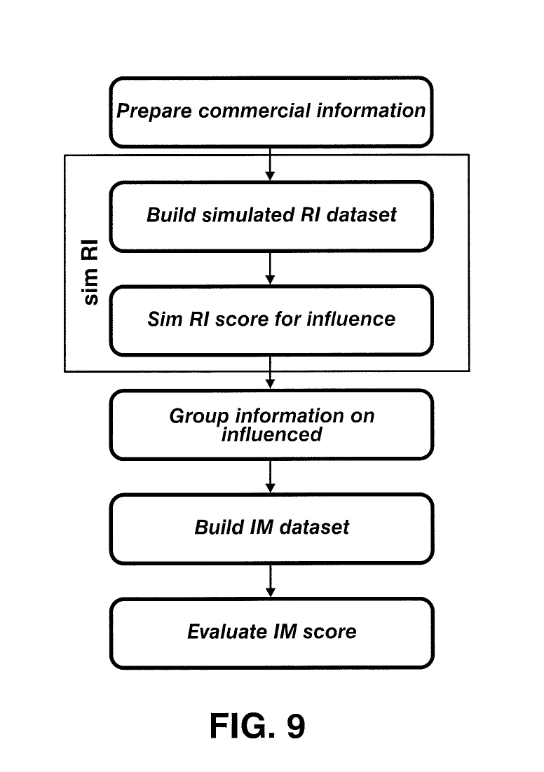

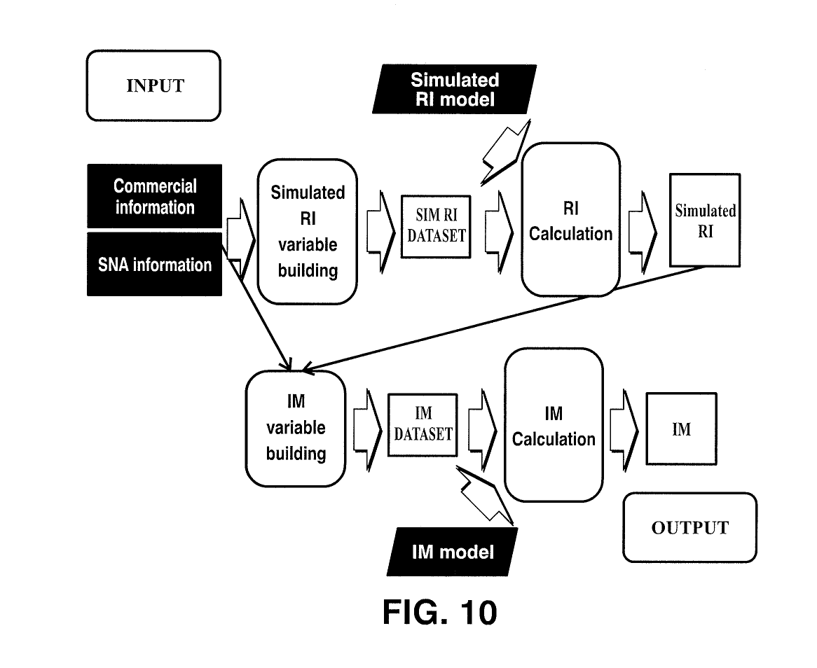

Finally, in order to elucidate the description of this component, it is provided the algorithm to implement the complete process described along this section (FIG. 9 and FIG. 10 stated graphically the inner of the algorithm textually described below).

Keep in mind that the following steps will be executed sequentially:

1. Prepare commercial information: Update information on new rumour adopters and subscribers.

2. Build simulated RI dataset: It must be generated by including the information about the users' contacts and neighbours as well as some other social metrics for each of the users we are analysing.

3. Evaluate simulated RI: Utilising a previously generated statistical model (binary classifier), a simulated RI score for each user is calculated.

4. Group information on influenced: Each user will influence other users. Those users will have a simulated RI score out of the simulation (supposing the first user followed the rumour which will have an impact on his neighbours). At this stage, some operations on the simulated RI can be run for each neighbour (count, addition, average, etc).

5. Build IM dataset: Combining the previously generated information (4) with information from social metrics, contacts and neighbours; a dataset for IM will be generated.

6. Evaluate IM: Applying a previously generated statistical model (binary classifier), it is possible to generate a score for each user based on the attributes that have been generated.

### ADVANTAGES OF THE INVENTION

Influence is measured and characterised based on observable user behaviours e.g. purchase of a product or churning from a telecommunications operator.
Complete view of the factors that affect customer behaviour.
Complete characterisation of user influence.
Full community view which takes into account the community structure that appears on social networks.
Different granularity of the characterisation of influence.
Integrated and actionable multi-dimensional view of influence.
Introduces operational considerations.
Scalable approach.

The applications of the invention are many-fold. The characterisation of user influence and the prediction of user behaviour can be applied to areas such as:
Design of viral marketing actions that maximise the impact of the campaign while reducing the number of users that have to be directly contacted or stimulated.
Design of member-get-member campaigns, where current users of a service are selected to optimise the attraction of new users.
Understanding the diffusion of information or rumours, for example about some disease, that creates a situation of alarm and can alter the behaviour of entire countries.
The detection of opinion leaders and those who are more influential.
Optimisation of CRM by having a characterisation of potential customer influence, which allows for e.g. designing loyalty programs specially tailored to influential customers under different criteria (number of other customers he can influence, value of these customers, socio-demographic characteristics of influenced customers . . . ).

A person skilled in the art could introduce changes and modifications in the embodiments described without departing from the scope of the invention as it is defined in the attached claims.

### ACRONYMS

CRM Customer Relationship Management

IM Influence Metrics

NIN Number of Influenced Nodes

NTIN Number of Truly Influenced Nodes

RI Received Influence

SI Sent Influence

SNA Social Network Analysis

VI Value of Influence

1. A computer-implemented method to characterise social influence and predict behaviour of a user, said user being part of a social network, characterised in that it comprises creating with computing means a multidimensional profile of a user including at least a prediction of behaviour of said user and a characterisation of social influence of said user, said prediction of behaviour comprising:
a) applying predictive models to individual factors, said individual factors being observable, declared or inferred characteristics of said user;
b) calculating influence received by said user from a social circle, said calculation based at least on previous events and Social Network Analysis Information, said previous events referred to behaviour or behaviours previously adopted by members of said social circle;
and said characterisation of social influence comprising simulating a determined behaviour in said user and estimating the effect caused over at least part of said members of said social circle.

2. A computer-implemented method as per claim 1, further comprising using history of user behaviour of said user when applying said predictive models in step a) and considering relation of said user with said members and/or general configuration of said social network when calculating received influence in step b).

3. A computer-implemented method as per claim 1, further comprising using said individual factors and said Social Network Analysis Information when performing said characterisation of social influence.

4. A computer-implemented method as per claim 1, comprising obtaining an individual score from step a), a received influence score from step b) and influence metrics from said characterisation of social influence, wherein said received influence score is a number between 0 and 1, a value of 0 indicating that said user does not receive any influence from said social circle and a value of 1 indicating that said user is highly influenced by said social circle.

5. A computer-implemented method as per claim 4, further comprising analysing said characterisation of said social influence across said influence metrics, said influence metrics being at least one of the following non-closed list: total number of users influenced, economic value of influenced users, social connectivity of influenced users and influence per micro-segments.

6. A computer-implemented method as per claim 5, wherein said micro-segments are age, socioeconomic level, interests and preferences and usage of technology.

7. A computer-implemented method as per claim 4, comprising generating an statistical model in order to be used to predict future events based on a dataset, said statistical model being a binary classifier and said generation comprising the following steps:
preparing information of said previous events in order to collect influence seeds, being an influence seed a person or group of people following a rumour or an event;
defining an influence area by considering said Social Network Analysis Information and said influence seeds, said influence area formed by users under influence, each user under influence belonging to a community in which there is an influence seed and have a direct link to said influence seed;
calculating a set of predictors for each user under influence based on parameters of the community of each user under influence and/or on parameters of said social network in order to obtain a training dataset, said training dataset containing said users under influence and their corresponding set of predictors; and
training a binary classifier with said training dataset using events of historical data in order to determine if a user under influence adopted the same behaviour as the influence seed that influenced said user under influence.

8. A computer-implemented method as per claim 7, wherein said community parameters are at least number of users belonging to said community, link strength of users belonging to said community and type of users of users belonging to said community.

9. A computer-implemented method as per claim 7, comprising calculating received influence scores for users under an influence area, one received influence score per each user, by applying said binary classifier to a scoring dataset, said scoring dataset obtained by calculating said set of predictors for said users under an influence area, being the influence seeds of said influence area different from the ones considered to obtain said training dataset.

10. A computer-implemented method as per claim 9 comprising gathering and combining information about social graph, influence seeds, social network metrics and/or commercial information of said social network when obtaining said training dataset and said scoring dataset, said social graph including said users under an influence area and contacts of these users under an influence area.

11. A computer-implemented method as per claim 9, comprising performing said characterisation of said social influence by simulating that each user of a neighbourhood or community follows a rumour or an event on study and performing the following steps:
generating a received influence dataset for each simulation with information about each user's contacts and neighbours and social network metrics;
calculating received influence scores for each simulation by applying said statistical model to said received influence dataset;
grouping received influence scores of all simulations in order to run some operations over them;
building an influence metrics dataset by combining results of said operations with information from social metrics, contacts and neighbours; and
applying said statistical model to said influence metrics dataset in order to obtain a set of influence metrics.
